(19) United States
(12) Patent Application Publication
(10) Pub. No.: US 2006/0061211 A1
(43) Pub. Date: Mar. 23, 2006

(54) Braking force retaining unit

(75) Inventors: Seiji Ohsaki, Saitama (JP); Hiroyasu Ishizuka, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/232,061

(22) Filed: Sep. 21, 2005

(30) Foreign Application Priority Data
Sep. 21, 2004 (JP) 2004-273155

(51) Int. Cl. B60T 8/34

(52) U.S. Cl. 303/113.4; 303/115.1

(57) ABSTRACT

A braking force retaining unit includes a cut-off valve disposed between a master cylinder and wheel cylinders in a brake hydraulic circuit. The cut-off valve being adopted to retain predetermined brake hydraulic pressure until a predetermined releasing condition is established even after the depression of a brake pedal is released when a vehicle is stopped, a one-way valve provided in parallel with the cut-off valve and adapted to permit a one-way passage of a brake fluid from a master cylinder side to a wheel cylinder side, a further application detecting sensor for detecting a further application of brakes, a further application determination unit for determining on an existence of the further application of brakes based an input from the further application detecting sensor and a valve control unit for opening the cut-off valve when the further application determination unit determines that the further application of brakes is occurred.

The present invention claims foreign priority to Japanese patent application no. P.2004-273155, filed on Sep. 21, 2004, the contents of which is incorporated herein by reference.

### BACKGROUND OF THE INVENTION

1. Field of the Invention

The present invention relates to a braking force retaining unit which can retain a braking force even after the depression of a brake pedal has been released.

2. Description of the Background Art

A braking force retaining unit is configured to include an electromagnetic or solenoid valve which operates electromagnetically at an intermediate position along the length of a brake hydraulic circuit so as to cut off the brake hydraulic circuit by supplying the solenoid valve with an electric current, whereby even after the driver releases the depressed brake pedal, brake hydraulic pressure is retained at the wheel cylinders, so that the vehicle is, for example, prevented from moving backward from its own weight when attempting to start climbing up a rising slope (Japanese Patent Unexamined Publications Nos. JP-A-2001-163197 (paragraphs 0034, 0070, 0072, and FIG. 2)). Incidentally, there occurs a case where the brake hydraulic pressure retained at the wheel cylinders needs to be increased by depressing further the brake pedal (hereinafter, referred to as a further application of brakes or simply as a further application) even in such a state that the solenoid valve is interrupted. To cope with this, a check valve is provided in parallel with the solenoid valve along the brake hydraulic circuit, so that the brake hydraulic pressure retained at the wheel cylinders can be increased by virtue of a further application even in such a state that the solenoid valve is interrupted (Japanese Patent Unexamined Publications Nos. JP-A-2001-163197 (paragraphs 0034, 0070, 0072, and FIG. 2), JP-A-2000-272486 (paragraph 0019 and FIG. 2)).

Incidentally, while the brake hydraulic pressure at the wheel cylinders can be increased by the check valve when the brake pedal is further depressed, since the cut-off valve is interrupted (closed), the fluid resistance of brake fluid is increased at the time of further application. Due to this, it has been desired that the further application can be implemented in a comfortable fashion.

### SUMMARY OF THE INVENTION

A primary problem that is to be solved by the invention is to provide a braking force retaining unit which can implement the further application of brakes in a comfortable fashion even when the braking force is retained.

With a view to solving the problem, according to a first aspect of the invention, there is provided a braking force retaining unit, comprising:

a cut-off valve disposed between a master cylinder and wheel cylinders in a brake hydraulic circuit, the cut-off valve being adopted to retain predetermined brake hydraulic pressure until a predetermined releasing condition is established even after the depression of a brake pedal is released when a vehicle is stopped;

a one-way valve provided in parallel with the cut-off valve and adapted to permit a one-way passage of a brake fluid from a master cylinder side to a wheel cylinder side;

a further application detecting sensor for detecting a further application of brakes;

a further application determination unit for determining on an existence of the further application of brakes based an input from the further application detecting sensor; and

a valve control unit for opening the cut-off valve when the further application determination unit determines that the further application of brakes is occurred.

According to this configuration, since, when the further application of brakes is detected at the further application detecting means, the valve control unit opens the cut-off valve, the flow and passage of brake fluid is enabled by virtue of further application of brakes. Note that opening the valve involves a case where the opening of the valve is assisted.

In addition, according to a second aspect of the invention, as set forth in the first aspect of the invention, there is provided a braking force retaining unit, wherein

the cut-off valve generates a cut-off force according to a current value supplied thereto in such a manner that the cut-off valve generates a large cut-off force when the current value supplied is large, whereas when the current value supplied is small, the cut-off valve generates a small cut-off force, so as to cut off a flow of brake fluid in the brake hydraulic circuit, and

the valve control unit reduces the current value, which is to be supplied to the cut-off value, or to make the current value zero, when the further application determination unit determines that the further application of brakes is occurred.

According to this configuration, since, when the further application of brakes is detected at the further application detecting means, the current value of a current that is supplied to the cut-off valve is reduced, the cut-off force is reduced, whereby the flow and passage of brake fluid by virtue of further application of brakes.

In addition, according to a third aspect of the invention, as set forth in the first aspect of the invention, there is provided a braking force retaining unit, wherein the further application detecting sensor is configured so as to detect a further application of brakes based on an input value that is supplied from at least one of:

a pressure sensor provided in the brake hydraulic circuit,

a brake pedal effort sensor provided in the brake pedal, and

a pedal stroke sensor provided in the brake pedal.

Additionally, according to a fourth aspect of the invention, as set forth in the first aspect of the present invention, there is provided a braking force retaining unit, wherein

the braking force retaining unit changes over a creeping drive force according to depressing conditions of the brake pedal between a large state and a small state which are both preset when a prime mover is idling and the vehicle is moving at a predetermined vehicle speed or smaller, and

the braking force retaining unit is installed on a vehicle which is provided further with a drive force control unit which puts the creeping drive force in the preset small state when the brake pedal is depressed and puts the creeping drive force in the preset large state when the depression of the brake pedal is released.

According to this configuration, when the vehicle is stopped (when the vehicle is moving at the predetermined vehicle speed or smaller), with the brake pedal depressed, the creeping drive force is put in the small state, whereas when the depression of the brake pedal is released, the creeping drive force is put in the large state.

According to the invention, a further application of brakes can be implemented in a comfortable fashion even when the braking force is retained.

### DESCRIPTION OF THE DRAWINGS

FIG. 1 is a drawing showing a system configuration of a vehicle in which a vehicle brake unit is installed to which a braking force retaining unit of an embodiment of the invention is applied;

FIG. 2 is a drawing showing the configuration of the vehicle brake unit in FIG. 1;

FIG. 3 is a drawing showing the configuration of a control unit in FIG. 2;

FIG. 4 is a control logic showing a condition for retaining brake hydraulic pressure (a condition for closing a solenoid valve);

FIG. 5 is a control logic showing a condition for releasing brake hydraulic pressure retained (a condition for opening the solenoid valve);

FIG. 6 is a control logic showing a condition for opening the solenoid valve by virtue of a further application of brakes;

FIG. 7 is drawings showing opened and closed states of the solenoid valve;

FIG. 7A shows a state when the vehicle is running normally;

FIG. 7B shows a state when brake hydraulic pressure is retained;

FIG. 7C shows a state when a further application of brakes occurs;

FIG. 7D shows a state when a further application of brakes occurs in a comparison example;

FIG. 8 is a flow chart illustrating an operation of the control unit when a further application of brakes occurs;

FIG. 9 is a control time chart from halt to start of the vehicle; and

FIG. 10 is a drawing showing the construction of a proportional solenoid valve.

### DETAILED DESCRIPTION OF THE PREFERRED EMBODIMENTS

Hereinafter, a best mode (hereinafter, referred to as an embodiment) for carrying out a braking force retaining unit of the invention will be described in detail by reference to the drawings.

A braking force retaining unit of the invention is applied to a brake unit of a four-wheeled vehicle having a prime mover and continues to retain a brake hydraulic pressure at respective wheel cylinders until a predetermined releasing condition is established even after the depression of a brake pedal is released. A brake hydraulic circuit of the brake unit is divided into two systems or lines, and the braking force retaining unit is provided for each of the divided systems. Note that the vehicle has a drive force control unit which changes over a creeping drive force according to depressing conditions of the brake pedal between a large state and a small state when the prime mover is idling and the vehicle is moving at a predetermined vehicle speed or smaller. When used herein, creeping means that a vehicle with an automatic transmission moves slowly as it were crawling even in the event that the acceleration pedal is not depressed (in such a state that the prime mover is idling) when a running range such as a D (drive) range or an R (reverse) range is selected.

<<System Configuration of Vehicle>>

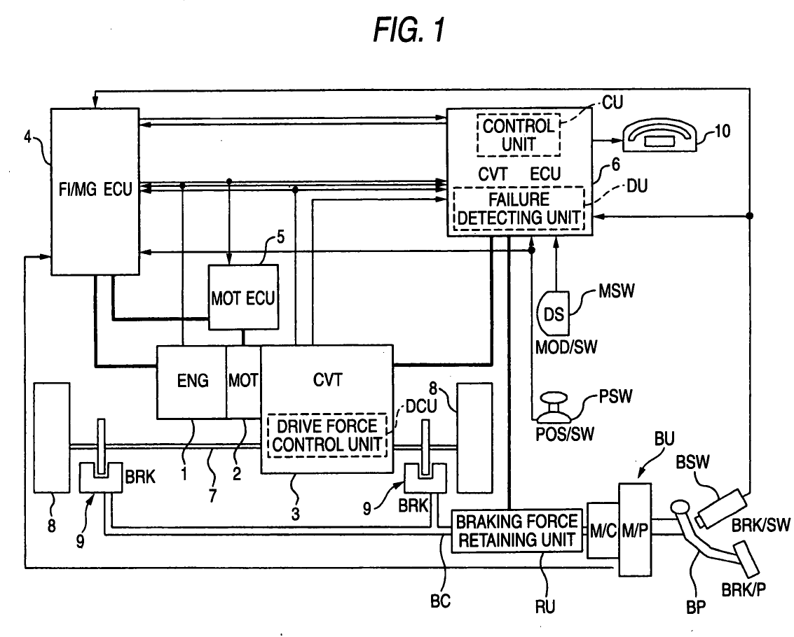

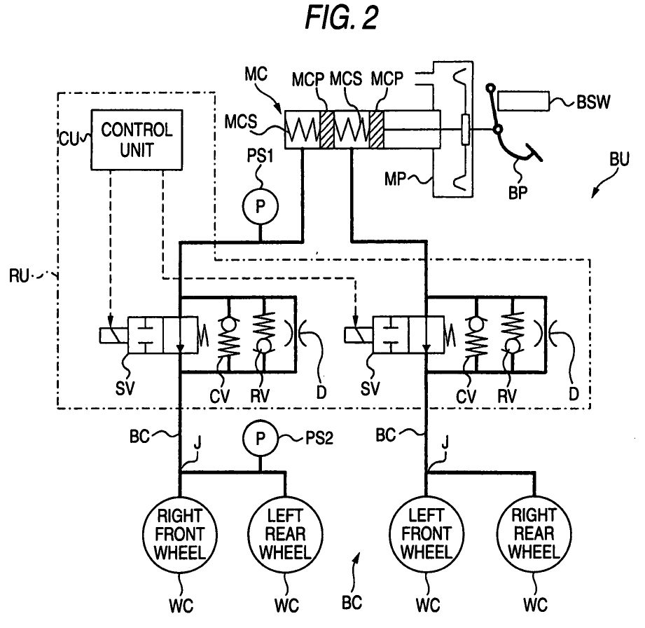

Firstly, the system configuration of a vehicle will be described by reference to FIGS. 1 and 2. FIG. 1 is a drawing which shows the system configuration of a vehicle in which a vehicle brake unit is installed to which a braking force retaining unit of the embodiment is applied. FIG. 2 is a drawing which shows the configuration of the vehicle brake unit in FIG. 1.

The vehicle which will be described in this embodiment is a hybrid vehicle having as prime movers an internal combustion engine 1 which uses gasoline as a drive source and a motor 2 which uses electricity as a drive source, and the hybrid vehicle incorporates therein a belt-type continuously variable transmission (hereinafter, referred to as CVT) 3 as a transmission. Note that the prime movers of the vehicle are not limited to those that have been described above but only the engine 1 or only the motor 2 may be used as the prime mover of the vehicle. In addition, the transmission of the vehicle is not limited to the CVT but an automatic transmission having a torque converter and a manual transmission may be used.

[Engine (Prime Mover), CVT (Transmission), Motor (Prime Mover)]

The engine 1 is controlled by a fuel injection electronic control unit (hereinafter, referred to as FIECU). Note that FIECU is configured so as to be integrated with a management electronic control unit (hereinafter, referred to as MGECU) and is included in a fuel injection/management electronic control unit (hereinafter, referred to as FI/MGECU) 4. In addition, the motor 2 is controlled by a motor electronic control unit (hereinafter, referred to as MOTECU) 5. Furthermore, the CVT 3 is controlled by a CVT electronic control unit (hereinafter, referred to as CVTECU) 6.

In addition, the CVT 3 is mounted on a drive shaft 7 on which two drive wheels 8, 8 are mounted. A disc brake 9 including a wheel cylinder WC (refer to FIG. 2) is equipped on the drive wheel 8. A master cylinder MC is connected to the wheel cylinders WC of the disc brakes 9 via a braking force retaining unit RU. A depression of a brake pedal BP is transmitted to the master cylinder MC via a master power MP. Whether or not the brake pedal BP is depressed is detected by a brake switch BSW.

The engine 1 is an internal combustion engine which makes use of thermal energy and drives the two drive wheels 8, 8 via the CVT 3 and the drive shaft 7. Note that there sometimes occurs a case where the engine 1 is automatically stopped when the vehicle is stopped in order to prevent the deterioration of fuel economy. Due to this, the vehicle includes an engine stopping unit for stopping the engine 1 when an engine automatic stopping condition is met.

The motor 2 has an assist mode in which the motor assists the engine 1 in driving the drive wheels by making use of electric energy from a battery, not shown. In addition, the motor 2 has a regeneration mode in which when no assist is required (when the vehicle is running down a falling slope or being decelerated), the motor 2 converts dynamic energy generated by virtue of rotation of the drive shaft 7 into electric energy for storage at the battery, as well as a starting mode in which the engine 1 is started by the motor 2.

The CVT 3 is such that an endless belt is wound around a drive pulley and a driven pulley and the wrap contact diameters of the endless belt with the respective pulleys are altered so as to produce a stepless change in speed ratios. Then, the CVT 3 connects a starter clutch to an output shaft for engagement and transmits an output of the engine 1 or the like which is changed in speed by the endless belt to the drive shaft 7 via a gear on an output side of the starter clutch. Note that the vehicle equipped with this CVT 3 can creep at the time of idling and is equipped with a drive force control unit DCU for reducing the drive force which enables the creeping.

[Drive Force Control Unit]

The drive force control unit DCU is fitted on the CVT 3 and changes over the magnitude of the creeping drive force by variably controlling the drive force transmitting capacity of the starter clutch. Note that the drive force control unit DCU is such as to incorporate in its configuration the CVTECU 6, which will be described later.

The drive force control unit DCU determines at the CVTECU 6 on a condition for realizing a weak creeping state, a condition for realizing an intermediate creeping state, a condition for realizing a strong creeping state and a condition for realizing a strong creeping state while running, which will be all described later, and alters the drive force transmitting capacity of the starter clutch so as to change over the drive force to a drive force that is preset for the creeping state so determined. Furthermore, the drive force control unit DCU determines on the respective conditions for changing over the creeping drive forces at the CVTECU 6 and sends an oil pressure command value for a linear solenoid valve for controlling the engagement oil pressure of the starter clutch from the CVTECU 6 to the CVT 3. Then, the drive force control unit DCU changes over the engagement force of the starter clutch at the CVT 3 based on the oil pressure command value. This also changes the drive force transmitting capacity, whereby the creeping drive forces are changed over. Note that the vehicle realizes an improvement in its fuel economy by virtue of the reduction in drive force by the drive force control unit DCU. The improvement of fuel economy is realized by virtue of the reduction in the load of the engine 1 and by virtue of the reduction in the load of a hydraulic pump in the starter clutch. When used herein, the drive force transmitting capacity means a maximum drive force (drive torque) that can be transmitted by the starter clutch. Namely, when a drive force generated in the engine 1 exceeds the drive force transmitting capacity, the starter clutch cannot transmit the drive force which exceeds the drive force transmitting capacity to the drive wheels 8, 8.

When running ranges are selected in the transmission even in such a state that the depression of an acceleration pedal is released at a predetermined vehicle speed or slower, the drive force control unit DCU transmits a drive force from the prime mover to the drive wheels 8 and changes over states of the drive force to be transmitted to the drive wheels 8 depending upon conditions of a brake pedal BP, that is, whether or not the brake pedal BP is depressed, in such a manner that the drive force is put in a small state when the brake pedal BP is depressed, whereas the drive force is put in a large state when the brake pedal is not depressed.

The reason why the drive force is put in the small state when the brake pedal BP is depressed is because the driver should be urged to depress the brake pedal BP hard so as to prevent the vehicle from moving backward from its own weight due to the collapse of the drive force from the engine 1 when the driver attempts to stop the vehicle on a rising slope. On the other hand, the reason why the drive force is put in the large state when the depression of the brake pedal BP is released is because the vehicle should be ready for start from rest or acceleration and the vehicle can be made to resist the aforesaid backward movement on the rising slope without depending upon braking force.

Note that the creeping drive force of the vehicle in this embodiment has three magnitudes such as (1) the large state, (2) the small state, and, in addition, (3) a state which is something like intermediate between the large state and the small state. Drive force transmitting capacities for the respective states are preset such that a large drive force transmitting capacity is for the large drive force state, a small drive force transmitting capacity is for the small drive force state and an intermediate drive force transmitting capacity is for the intermediate drive force state.

In this embodiment, the large drive force (creeping drive force) state is referred to as a strong creeping state, the small drive force state is referred to as a weak creeping state and the intermediate drive force state between the large drive force state and the small drive force state is referred to as an intermediate creeping state. Furthermore, in the strong creeping state, there are a level at which the drive force is large and a level at which the drive force is small, and the large drive force level is simply referred to as a strong creeping state and the small drive force level is referred to as a strong creeping state while running. The strong creeping state is a state in which a drive force is provided which is balanced with an inclination of 5°. The strong creeping state while running provides a drive force which is smaller than the drive force provided in the strong creeping state and constitutes a state at a stage prior to one where the drive force is changed over to the weal creeping state. The weak creeping state is a state in which there exist almost no drive force. The intermediate creeping state is a state in which there is provided an intermediate drive force that falls substantially between the strong creeping state and the weak creeping state and constitutes an intermediate state resulting when the drive force is reduced in a stepped fashion in a process in which the creeping state is changed over from the strong creeping state to the weak creeping state. The strong creeping state is realized when the depression of the acceleration pedal is released at the predetermined vehicle speed or slower (namely, when the idling state is taking place) and a position switch PSW selects the running ranges, and the vehicle moves slowly as if it were crawling upon releasing the depression of the brake pedal BP. The weak creeping state is realized when the brake pedal BP is depressed further, in which the vehicle stops or moves at extremely low vehicle speeds.

[Position Switch]

Ranges of the position switch PSW is selected with a shift lever. The ranges of the position switch PSW includes a P range which is used when parking the vehicle, an N range which is a neutral position, an R ranged which is used when reversing the vehicle, a D range which is used when running the vehicle normally and an L range which is used when drastically accelerating the vehicle or needing strong engine brake. In addition, running ranges are range positions where the vehicle can run and includes, in the case of this vehicle, three ranges such as the D range, the L range and the R range. Furthermore, when the position switch PSW selects the D range, a D mode, which is a normal running mode, and an S mode, which is a sports running mode, can be selected by a mode switch MSW. Incidentally, information of the position switch PSW and the mode switch MSW is sent to the CVTECU 6 and further to an instrument cluster 10. The instrument cluster 10 displays range information and mode information which are selected by the position switch PSW and the mode switch MSW, respectively.

Note that in this embodiment, the aforesaid reduction of creeping drive force (namely, putting the drive force in the intermediate creeping state and the weak creeping state) is carried out when the position switch PSW is in the D range or the L range but is not carried out when the position switch PSW is in the R range, and the strong creeping state is retained. In addition, while no drive force is transmitted to the drive wheels 8, 8 in the N and P ranges, the drive force transmitting capacity is reduced and the drive force is formally changed over to the weak creeping state.

[ECU's]

The FIECU, which is incorporated in the FI/MGECU 4, controls the injection amount of fuel so as to realize an optimal air-fuel ration and generally controls the engine 1. Information indicating a throttle opening and the state of the engine 1 is sent to the FIECU, which controls the engine 1 based on the respective pieces of information. In addition, the MGECU incorporated in the FI/MGECU 4 controls mainly the MOTECU 5 and determines on an engine automatic stopping condition and an engine automatic starting condition. Information indicating the state of the motor 2 is sent to the MGECU and information indicating the state of the engine 1 is inputted from the FIECU into the MGECU, whereby an instruction on the changeover of the modes of the motor 2 or the like is given to the MOTECU 5 based on the respective pieces of information. In addition, information indicating the state of the CVT 3, information indicating the state of the engine 1, range information the position switch PSW and information indicating the state of the motor 2 are sent to the MGECU, whereby the MGECU determines on automatic stopping of the engine 1 or automatic starting of the engine 1 based on the respective pieces of information.

The MOTECU 5 controls the motor 2 based on control signals from the FI/MGECU 4. The control signals from the FI/MGECU 4 include mode information which instructs the motor 2 to start the engine 1, to assist in driving the engine 1 or to regenerate electric energy and output requesting values relative to the motor, and the MOTECU 5 sends out a command to the motor based on the information. In addition, the MOTECU 5 obtains information from the motor 2 or the like and transmits information on the motor 2 such as an amount of power generation and the capacity of the battery to the FI/MGECU 4.

The CVTECU 6 controls the speed ratio of the CVT 3 and the drive force transmitting capacity of the starter clutch. Information indicating the state of the CVT 3, information indicating the state of the engine 1 and range information of the position switch PSW are sent to the CVTECU 6, and the CVTECU 6 transmits signals to control the oil pressure of respective cylinders of the drive pulley and the driven pulley of the CVT 3 and the oil pressure of the starter clutch to the CVT 3.

Furthermore, the CVTECU 6 includes a control unit CU (details of which will be described later) which controls ON (closing) and OFF (opening) of electromagnetic or solenoid valves SV (refer to FIG. 2) of the braking force retaining unit RU. In addition, the CVTECU 6 determines on the changeover of the creeping drive force and transmits information on the determination so made to the drive force control unit DCU of the CVT 3.

[Prime Mover Stopping Unit]

A prime mover stopping unit provided on the vehicle is made up of the FI/MGECU 4 and the like. The prime mover stopping unit can automatically stop the engine 1 when the vehicle is at halt. The prime mover stopping unit determines on an engine automatic stopping condition at the FI/MGECU 4 and the CVTECU 6. Note that the engine automatic stopping condition will be described in detail later on. Then, when determined that the engine automatic stopping condition is all met, an engine stopping command is sent to the engine 1 from the FI/MGECU 4 so that the engine 1 is automatically stopped. The vehicle realizes a further improvement in fuel economy by virtue of the automatic stopping of the engine by the prime mover stopping unit.

Note that when the engine 1 is automatically stopped by the prime mover stopping unit, the automatic starting condition of the engine 1 is determined at the FI/MGECU 4 and the CVTECU 6. Then, when the engine automatic starting condition is met, a command to start the engine 1 is sent to the MOTECU 5 from the FI/MGECU 4, and furthermore, a command to start the engine 1 is sent to the motor 2 from the MOTECU 5, so that the engine 1 is automatically started by the motor 2 and the strong creeping state is produced. Note that the automatic starting condition of the engine 1 will be described in detail later on.

[Brakes (Vehicle Brake Unit)]

A vehicle brake unit BU is configured so as to include the master cylinder MC, a brake hydraulic circuit BC, the wheel cylinders WC, the braking force retaining unit RU (the solenoid valves SV) and the like and applies braking force to the vehicle based on the will of the driver so as to retard of stop the vehicle. In addition, as has been described above, the vehicle brake unit BU retains brake hydraulic pressure at the wheel cylinders WC until the predetermined releasing condition is established even after the depression of the brake pedal BP is released when the vehicle is started from rest.

A piston MCP is inserted in a main body of the master cylinder MC, and the piston MCP is pushed when the driver depresses the brake pedal BP, whereby a brake fluid within the master cylinder MC is pressurized so that a mechanical force is converted into a brake hydraulic pressure (a pressure applied to the brake fluid). When the driver removes the foot from the brake pedal BP so as to release the depression of the brake pedal BP, the piston MPC is returned to its original position by virtue of a force of a return spring MCS, and at the same time, the brake hydraulic pressure is returned to its original state. The master cylinder MC shown in FIG. 2 is a tandem master cylinder in which two pistons MCP are arranged in a straight line so as to divide the main body of the master cylinder into two to provide two independent brake hydraulic circuits BC from the viewpoint of fail and safe.

In order to reduce the pedal effort on the brake pedal BP, a master power MP (a brake booster) is provided between the brake pedal BP and the master cylinder MC. The master cylinder MC shown in FIG. 2 is of a vacuum (negative pressure) servo type in which vacuum is taken out of an intake manifold of the engine 1 so as to facilitate the operation of the brake pedal BP by the driver.

The brake hydraulic circuit BC connects the master cylinder MC to the wheel cylinders WC and serves as a flow path of brake fluid which transfers brake hydraulic pressure generated in the master cylinder MC to the wheel cylinders by moving the brake fluid. In addition, in the event that the brake hydraulic pressure as the wheel cylinders is higher than that at the master cylinder MC, the brake hydraulic circuit serves as a flow path of brake fluid which returns the brake fluid to the master cylinder MC.

Note that as shown in FIG. 2, the brake hydraulic circuit BC is divided into two independent systems or lines. In this embodiment, the brake hydraulic circuit BC utilizes a crossed brake pipe line system or a diagonally front to rear brakes split in which one of the two brake hydraulic circuits BC applies brakes to the right front wheels and the left rear wheels, whereas the other brake hydraulic circuit BC applies brakes to the left front wheel and the right rear wheel. Due to this, both the brake hydraulic circuits BC is forked into two branches at branch points J which are situated at intermediate positions along the length of the circuits, so that the respective brake hydraulic circuits connect to the two wheel cylinders WC, WC. Incidentally, the brake hydraulic circuit BC does not always have to adopt the crossed brake pipe line system but may adopt a front to rear brake line split in which one of the two divided brake hydraulic circuits applies brakes to both the front wheels, whereas the other brake hydraulic circuit applies brakes to both the rear wheels.

Four wheel cylinders WC are provided, one for each wheel, and serves to convert brake hydraulic pressure that is generated in the master cylinder MC and is then transferred to the wheel cylinders WC through the brake hydraulic circuits BC into a mechanical force (braking force) to apply brakes to the respective wheels. Note that a piston is inserted into a main body of the wheel cylinder WC, and this piston is pushed by virtue of brake hydraulic pressure, so that, brake pads, in the case of a disc brake, and brake shoes, in the case of a drum brake, are activated so as to generate braking force which retards the respective wheels.

As shown in FIG. 2, the braking force retaining unit RU includes solenoid valves SV, diaphragms D, check valves CV and relief valves RV and retains braking force by retaining brake hydraulic pressure at the wheel cylinders WC which are incorporated in the brake hydraulic circuits BC which connect the master cylinder MC to the wheel cylinders WC. Note that the braking force retaining unit RU is such as to include the control unit CU in its configuration.

The solenoid valve SV is provided along the brake hydraulic circuit BC which connects the master cylinder MC of the vehicle brake unit BU which is a hydraulic brake unit and the wheel cylinders WC. In addition, in this embodiment, the solenoid valve SV is provided along the brake hydraulic circuit BC between the master cylinder MC and the branch point J. This solenoid valve SV is of a normally opened type and is closed by receiving a breaking current of a predetermined magnitude from the control unit CU. Note that when closed, the solenoid valve SV interrupts the flow of brake fluid within the brake hydraulic circuit BC so as to retain brake hydraulic pressure applied to the wheel cylinders WC, whereas when opened, the solenoid valve SV permits the flow of brake fluid within the brake hydraulic circuit BC.

Brake hydraulic pressure is retained at the wheel cylinders WC by the solenoid valve SL even in the event that the driver releases the depression of the brake pedal PB when attempting to start the vehicle from rest on a rising slope, thereby making it possible to prevent the vehicle from moving backward or reversing from its own weight. Note that when used herein, reversing means that the vehicle moves from its own weight in an opposite direction to a direction in which the driver intends to drive the vehicle (or descends a slope).

The diaphragm D is provided in parallel with the solenoid valve SV as required and conducts brake hydraulic pressure (or communicates) between the master cylinder MC and the wheel cylinders whether the solenoid valve SV is opened or closed. In particular, in the event that the driver releases or relaxes the depression of the brake pedal BP with the solenoid valve SV closed, the diaphragm D makes brake fluid confined in the wheel cylinders escape to the master cylinder side thereof in a gradual fashion so as to reduce the brake hydraulic pressure at the wheel cylinders WC at a predetermined speed. The diaphragm can be formed by providing a portion which constitutes a resistance against the fluid (a portion where the area of the flow path is reduced) at a position along the length of the flow path of brake fluid that is provided in parallel with the solenoid valve SV.

Even when the solenoid valve SV is closed, in the event that the driver releases or relaxes the depression of the brake pedal BP, there is caused no state in which brakes are kept applied due to the existence of the diaphragm D, and hence the brake hydraulic pressure (braking force) is gradually reduced. Namely, the speed at which the brake hydraulic pressure within the wheel cylinder can be made slower than the speed at which the depressing force applied to the brake pedal BP is reduced, whereby the braking force is sufficiently reduced in a predetermined period of time even when the solenoid valve SV is closed, thereby making it possible to start the vehicle from rest (on a rising slope) by virtue of the drive force of the prime mover. In addition, on a falling slope, the driver can also start the vehicle from its own weight only if he or she releases or relaxes the depression of the brake pedal BP without depressing the accelerator pedal.

In addition, as long as the brake hydraulic pressure at the master cylinder MC is higher than the brake hydraulic pressure at the wheel cylinders WC with the brake pedal BP depressed by the driver, there is caused no case where the braking force is reduced due to the existence of the diaphragm D. This is because the diaphragm D serves to allow the brake fluid to flow from where the brake hydraulic pressure is higher to where the brake hydraulic pressure is lower by virtue of a difference in brake hydraulic pressure between the wheel cylinders WC and the master cylinder MC (a differential pressure). Namely, as long as the driver does not relax the depression of the brake pedal BP, there is caused no case where the brake hydraulic pressure at the wheel cylinders WC is reduced while there exists a case where the brake hydraulic pressure thereat is increased due to the existence of the diaphragm D. A configuration may be adopted in which a flow of brake fluid from the master cylinder MC side to the wheel cylinder WC side thereof by giving a check valve function.

The speed at which the brake hydraulic pressure at the wheel cylinders WC is reduced may be such as to prevent the reversing of the vehicle while the driver releases the depression of the brake pedal BP so as to shift the creeping drive force from the weak creeping state to the strong creeping state. Note that in the event that the speed at which the brake hydraulic pressure at the wheel cylinders WC is faster, the braking force collapses as soon as the depression of the brake pedal BP is released even with the solenoid valve SV closed, the vehicle is forced to move backwards a rising slope before a sufficient drive force is obtained. In contrast, in the event that the speed at which the brake hydraulic pressure at the wheel cylinders WC is slower, while the vehicle is kept from reversing because a state in which brakes are applied well enough continues even in case the depression of the brake pedal BP is released, extra time and power are required in order to secure a drive force which resists the braking force applied, and hence it is not preferable. Incidentally, in the vehicle of this embodiment, as will be described later on, since the solenoid valve SV is controlled to be opened again at a point in time when a starting drive force is generated in the vehicle and the depression of the brake pedal BP is released, there will be no problem even in case the speed at which the brake hydraulic pressure at the wheel cylinders WC is reduced is slower in starting the vehicle by virtue of the starting drive force so generated in the vehicle.

While the check valve CV is provided in parallel with the solenoid valve SV with a view to facilitating a further application of brakes, this check valve CV serves to transfer a brake hydraulic pressure generated at the master cylinder MC when the driver further depresses the brake pedal BP to the wheel cylinders WC. The check valve CV functions effectively when the brake hydraulic pressure so generated at the master cylinder MC exceeds the brake hydraulic pressure at the wheel cylinders WC to thereby increase the brake hydraulic pressure at the wheel cylinders WC according to the further depression of the brake pedal BP by the driver.

While a relieve valve RV is provided in parallel with the solenoid valve SV as required, this relieve valve RV serves to allow the brake fluid confined in the wheel cylinders WC to escape to a master cylinder MC side thereof without no delay until a predetermined brake hydraulic pressure (a relief pressure) is attained when the solenoid valve SV is closed and also when the driver releases or relaxes the depression of the brake pedal BP. The relief valve RV is activated in a condition in which the brake hydraulic pressure at the wheel cylinders WC is equal to or higher than a predetermined brake hydraulic pressure and is higher than the brake hydraulic pressure at the master cylinder MC, whereby even when the solenoid valve SV is closed, the brake hydraulic pressure within the wheel cylinders WC which is unnecessarily too high can be reduced to the relief pressure without delay. Consequently, the vehicle can be started quickly even in the event that the driver depresses the brake pedal BP unnecessarily too hard. Incidentally, in the vehicle of the embodiment, the relief valve RV ensures its existence when the vehicle is not started by virtue of starting drive force, for example, when the vehicle move downwards a falling slope from its own weight by relaxing the depression of the brake pedal BP.

In addition, the brake switch BSW detects whether or not the brake pedal BP is depressed and transmits a signal carrying a result of the detection to the CVTECU 6 (the control unit CU). In addition, a brake hydraulic pressure sensor PS1 detects a brake hydraulic pressure on a master cylinder MC side of the solenoid valve SV and transmits a signal carrying a result of the detection to the CVTECU 6 (the control unit CU). A brake hydraulic sensor PS2 detects a brake hydraulic pressure on a wheel cylinder WC side of the solenoid valve SV and transmits a signal carrying a result of the detection to the CVTECU 6 (the control unit CU). These brake hydraulic pressure sensors PS1, PS2 correspond to a further application detecting sensor which detects a further application of brakes.

[Control Unit]

The control unit CU provided in the CVTECU 6 is configured so as to include various types of electric circuits and electronic circuits in addition to not shown CPU, memory, input/output interface, bus and the line and controls the braking force retaining unit RU.

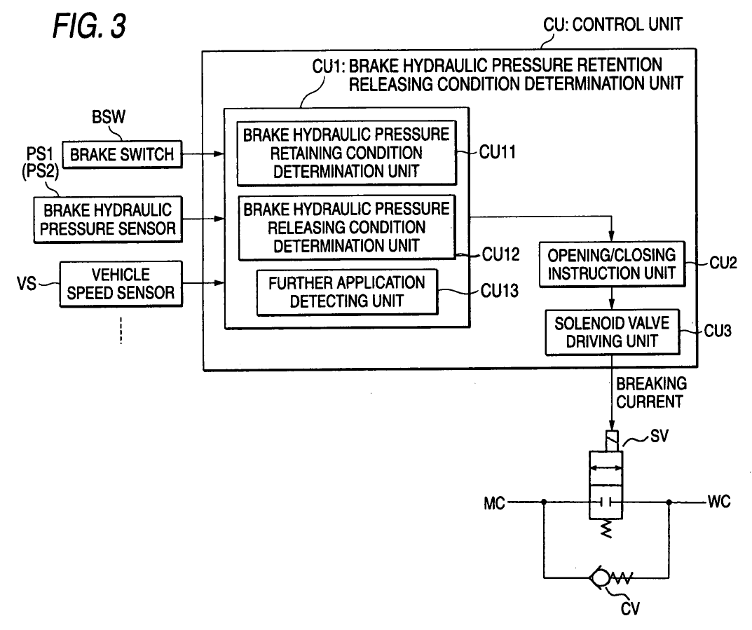

FIG. 3 is a diagram showing the configuration of the control unit. As shown in FIG. 3, the control unit CU is configured so as to include a brake hydraulic pressure retention releasing condition determination unit CU1, an opening/closing instruction unit (a valve control unit) CU2 and a solenoid valve driving unit CU3.

Of these, the brake hydraulic pressure retention releasing condition determination unit CU1 determines by receiving signals inputted from the brake switch BSW and a vehicle speed sensor VS whether or not a brake hydraulic pressure retaining condition (a condition for closing the solenoid valve SV) is met and whether or not a brake hydraulic pressure releasing condition (a condition for opening the solenoid valve SV) is met. Due to this, the brake hydraulic pressure retention releasing condition determination unit CU1 includes a brake hydraulic pressure retaining condition determination unit CU11 and a brake hydraulic pressure releasing condition determination unit CU12. Furthermore, in order to determine whether or not a further application of brakes has been carried out, the brake hydraulic pressure retention releasing condition determination unit CU1 includes a further brake application determination unit CU13 which carries out the determination by receiving signals inputted from the brake hydraulic pressure sensors PS1, PS2. These determination units CU11, CU12, CU13 are configured so as to output signals carrying results of the respective detections to the opening/closing instruction unit CU2 which is provided at a later stage.

Note that the further brake application determination unit CU13 calculates from the following equation a difference in brake hydraulic pressure (a differential pressure) by receiving signals (brake hydraulic pressures) inputted from the brake hydraulic pressure sensors PS1, PS2 and determines that a further application of brakes has been carried out when the differential pressure so calculated is larger than a predetermined differential pressure, whereas it determines that no further application of brakes has been carried out in any other cases. A signal carrying a result of this determination is designed to be also sent to the opening/closing instruction unit CU2 at the later stage.
Differential Pressure=Brake Hydraulic Pressure at Sensor PS1−Brake Hydraulic Pressure at Sensor PS2 Equation 1

The opening/closing instruction unit CU2 is configured so as to output by receiving the signal carrying the result of the determination a signal which instructs opening or closing of the solenoid valve SV to the solenoid valve driving unit CU3 at the later stage. To be specific, in the event that a signal carrying the result of the detection which indicates that the condition for closing the solenoid valve SV is met is inputted in the opening/closing instruction unit CU2, the opening/closing instruction unit CU2 outputs a signal instructing closing of the solenoid valve SV to the solenoid valve driving unit CU3 at the later stage, whereas in the event that a signal carrying the result of the detection which indicates that the condition for opening the solenoid valve SV is met is inputted in the opening/closing instruction unit CU2, the opening/closing instruction unit CU2 outputs a signal instructing opening of the solenoid valve SV to the solenoid valve driving unit CU3 at the later stage. Note that even in the event that the signal is inputted which indicates that the condition for closing the solenoid valve SV is met, when the signal is inputted which carries the result of the detection indicating that the further application of brakes has been carried out, the opening/closing instruction unit CU2 outputs a signal instructing opening of the solenoid valve SV. This opening/closing instruction unit CU2 corresponds to a valve control unit for opening the cut-off valve when the further application of brakes is determined to have occurred by the further application determination unit.

The solenoid valve driving unit CU3 is electrically connected to a battery, not shown, and is configured so as to supply a breaking current of a predetermined magnitude. In addition, the supply of breaking current to the solenoid valve SV is implemented when a signal instructing closing of the solenoid valve SV is inputted from the opening/closing instruction unit CU2 into the solenoid valve driving unit CU3, whereas the supply of breaking current to the solenoid valve SV is implemented when a signal instructing opening of the solenoid valve SV is inputted from the opening/closing instruction unit CU2 into the solenoid valve driving unit CU3. Incidentally, the solenoid valve SV of the embodiment is a solenoid valve of a normally opened type and is configured so as to be closed when a breaking current is supplied and to be opened when the supply of breaking current is stopped.

[Condition for Retaining Brake Hydraulic Pressure]

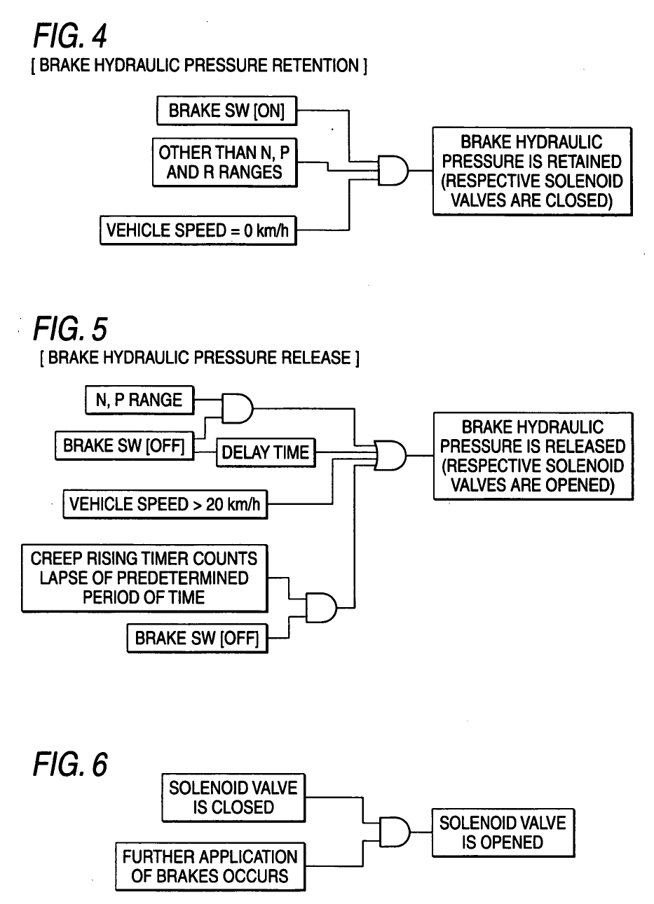

FIG. 4 is a control logic showing a condition for retaining brake hydraulic pressure (a condition for closing the solenoid valve). The brake hydraulic pressure retaining condition determination unit CU11 determines whether or not the condition for retaining brake fluid pressure is met based on the control logic shown in FIG. 4. In this control logic, the result of the detection constitutes a detection result asserting that the condition for retaining brake hydraulic pressure is met (the condition for closing the solenoid valve SV is met) only when (1) the brake switch BSW is ON, (2) the shift position is in other ranges than N, P and R ranges and (3) the vehicle speed=km/h. As a result of this, the solenoid valve SV is closed.

[Condition for Releasing Brake Hydraulic Pressure]

FIG. 5 is a control logic showing a condition for releasing a retained brake hydraulic pressure (a condition for opening the solenoid valve). The brake hydraulic pressure releasing condition determination unit CU12 determines whether or not a condition for releasing a retained brake hydraulic pressure is met based on this control logic. In this control logic, the result of the detection constitutes an assertion that a condition for releasing brake hydraulic pressure is met (a condition for opening the solenoid valve SV is met) when any of the following four conditions is met: (1) the shift position is in the N or P range and the brake switch BSW is OFF; (2) a delay time has elapsed since the brake switch BSW was switched OFF; (3) the vehicle speed exceeds 20 km/h; and (4) a creep rising timer counts a predetermined period of time and the brake switch BSW is OFF. As a result of this, the solenoid valve SV is opened.

Incidentally, according to the control logic, even when the driver releases the depression of the brake pedal BP, in the event that the shift position is in the N or P range (non-running range), there is no case where brake hydraulic pressure is retained. In addition, even when the shift position is in the running ranges, in the event that a delay time (for example, two seconds) has elapsed since the driver released the depression of the brake pedal BP, the retention of brake hydraulic pressure is released. The conditions (2) and (3) are set from the viewpoint of eliminating brake dragging.

[Condition for Opening Solenoid Valve due to Further Application of Brakes]

FIG. 6 is a control logic showing a condition for opening the solenoid valve due to a further application of brakes. The opening/closing instruction unit CU2 determines whether or not a condition for opening the solenoid valve SV due to a further application of brakes is met based on the control logic shown in FIG. 6. In this control logic, the solenoid valve SV is opened on condition that (1) the solenoid valve is closed and (2) a further application of brakes occurs. Note that the determination on whether or not a further application of brakes has occurred is made, as has been described before, by calculating a differential pressure by the equation 1.

[Operation of Braking Force Retaining Unit]

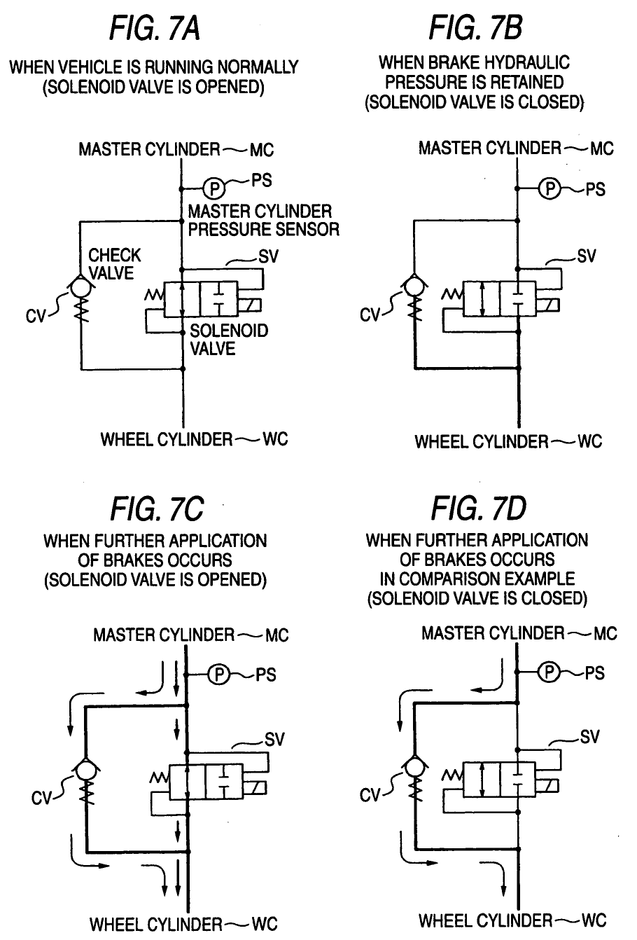

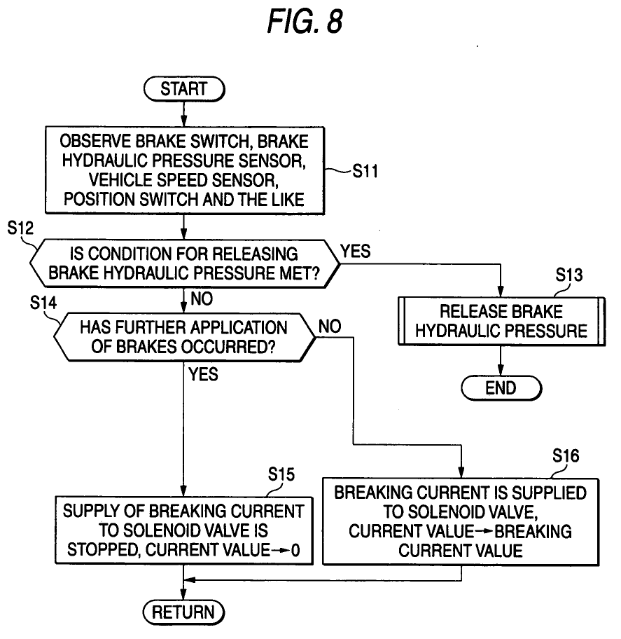

The operation of the braking force retaining unit that has been described heretofore will be described by reference to a drawing showing opened and closed states of the solenoid valve (FIG. 7), a flowchart showing the operation of the control unit when a further application of brakes occurs (FIG. 8) and a time chart showing controls from stopping to starting the vehicle.

[Opened/Closed States of Solenoid Valve]

FIG. 7 shows opened and closed states of the solenoid valve, in FIG. 7A a state resulting when the vehicle runs normally, (b) a state resulting when brake hydraulic pressure is retained, and (c) a state resulting when a further application of brakes occurs, and FIG. 7D shows a state of a solenoid valve of a comparison example when a further application of brakes occurs.

When the vehicle runs normally, the solenoid valve SV is opened as shown in FIG. 7A. Due to this, brake fluid can flow through the solenoid valve SV freely from the master cylinder MC side to the wheel cylinder WC side thereof or in an opposite direction thereto. Next, when brake hydraulic pressure is retained, the solenoid valve SV is closed as shown in FIG. 7B. Due to this, brake hydraulic pressure is retained at the wheel cylinders WC, whereby in starting the vehicle from rest on a rising slope, the vehicle is restrained from moving backwards from its own weight from the depression of the brake pedal BP is released until for example, the accelerator pedal is depressed.

Then, when a further application of brakes occurs, the solenoid valve SV is opened as shown in FIG. 7C. Due to this, since brake fluid can flow through both the solenoid valve SV and the check valve CV from the master cylinder MC sides to the wheel cylinder WC sides thereof, the further application of brakes can be facilitated. Incidentally, in the comparison example shown in FIG. 7D, since brake fluid flows only through a check valve CV to a wheel cylinder WC side thereof when a further application of brakes occurs, the fluid resistance becomes large compared with FIG. 7C, this making difficult the further application of brakes.

[Operation of Control Unit when Further Application of Brakes Occurs]

Referring to FIG. 2, the operation of the control unit when a further application of brakes occurs will be described along the flowchart in FIG. 8. FIG. 8 is a flowchart illustrating an operation of the control unit when a further application of brakes occurs. Note that as a premise to the flowchart shown, the brake pedal BP is depressed so as to stop the vehicle, a breaking current is supplied to the solenoid valve SV so as to close the same and brake hydraulic pressure is retained at the wheel cylinders WC.

In a situation where brake hydraulic pressure is retained, the control unit CU observes the brake switch BSW, the brake hydraulic pressure sensors PS1, PS2, the vehicle speed sensor, the position switch PSW (refer to FIG. 1) and the like (S11) and signals are inputted thereinto from them. The brake hydraulic pressure releasing condition determination unit CU12 determines whether or not the condition for releasing brake hydraulic pressure is met based on signals inputted thereinto (S12). If met (Yes), brake hydraulic pressure is released (S13). Namely, the brake hydraulic pressure releasing condition determination unit CU12 outputs to the opening/closing instruction unit CU2 a signal carrying a result of the determination that the condition is met, and the opening/closing instruction unit CU2 generates and outputs to the solenoid valve driving unit CU3 a signal instructing opening of the solenoid valve, whereby since the solenoid valve driving unit CU3 stops the supply of the breaking current to the solenoid valve SV, the solenoid valve SV is opened. Then, the process based on this flowchart is completed (Ends).

On the other hand, if the brake hydraulic pressure releasing condition is not met (if No in S12), the further application determination unit CU13 determines whether or not a further application has occurred (S14). If a further application is determined to have occurred, the supply of breaking current to the solenoid valve SV is stopped (S15). For example, in the event that the driver feels that the vehicle is moving backwards, when the driver depresses the brake pedal BP for a further application of brakes, the further application determination unit CU13 outputs a signal carrying a result of the determination that a further application of brakes is being implemented to the opening/closing instruction unit CU2, and the opening/closing instruction unit CU2 generates and outputs to the solenoid valve driving unit CU3 a signal carrying a valve opening instruction, whereby since the solenoid valve driving unit CU3 stops the supply of breaking current to the solenoid valve SV, the solenoid valve SV is opened. As a result of this, as shown in FIG. 7C, brake fluid is allowed to flow through the solenoid valve SV and the check valve CV so as to be supplied to the wheel cylinder WC sides thereof by virtue of the further application, whereby the further application of brakes is facilitated compared with a conventional further application of brakes with a check valve CV only (refer to FIG. 7D).

If no further application of brakes occurs or a further application of brakes is interrupted midway during the application (if No in S14), breaking current is supplied to the solenoid valve SV (S16), whereby since the solenoid valve SV is closed, even in the event that the driver relaxes the depression of the brake pedal BP, a brake hydraulic pressure generated when the further application was implemented is retained at the wheel cylinders WC.

[Control Time Chart]

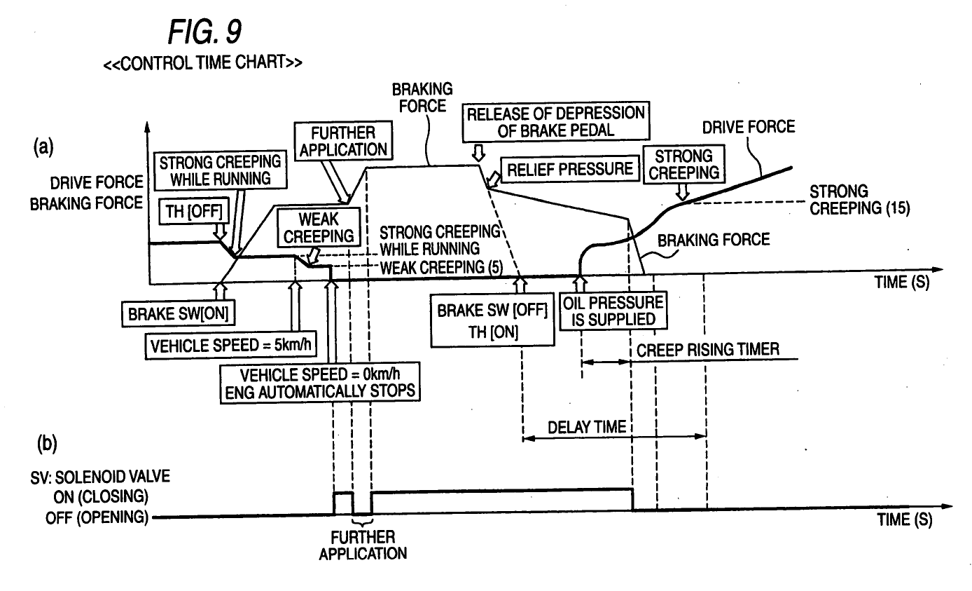

Next, how the vehicle, which has been specifically described heretofore, is controlled will be described by taking as an example a control of the vehicle when it is running by reference to a control time chart (FIG. 9) showing a process of control to be implemented from stopping to starting of the vehicle (refer appropriately to FIGS. 1 to 8).

In a control shown in FIG. 9, it is assumed that the vehicle is stopped on a rising slope. In addition, it is also assumed that the position switch PSW and the mode switch MSW of the vehicle remain in the D range and the D mode, respectively. In addition, the braking force retaining unit RU is understood to be configured so as to be provided with the relief valve RV. Here, a control time chart shown in FIG. 9(a) is a diagram showing a fluctuation of drive force and braking force of the vehicle in the form of time series. A thick solid line in the diagram shows drive force and a thin solid line shows braking force. A control time chart in FIG. 9(b) is a diagram showing ON (opening) and OFF (closing) of the solenoid valve sv.

Firstly, when the driver releases the depression of the accelerator pedal (TH[OFF]) while the vehicle is running (vehicle speed>5 km/h, incidentally), the drive force control unit DCU generates an instruction of strong creeping while running to thereby produce a state of strong creeping while running. Due to this, the drive force is reduced from that in the strong creeping state.

At the same time that the driver releases the depression of the accelerator pedal, the driver depresses the brake pedal BP (brake switch SW[ON]), braking force is increased as brake hydraulic pressure is increased. Then, when the brake pedal BP continues to be depressed so that the vehicle speed reaches 5 km/h, the drive force control unit DCU generates an instruction of weak creeping to thereby produce a weak creeping state. As this occurs, since the drive force is shifted from the state of strong creeping while running to the weak creeping state, the driver does not have to feel a strong feeling of deceleration.

Then, when the vehicle speed is reduced down to reach 0 km/h, the control unit CU supplies breaking current to the solenoid valve SV so as to open (ON) the solenoid valve SV to thereby retain brake hydraulic pressure (braking force) at the wheel cylinders WC. Furthermore, the prime mover stopping unit automatically stops the engine 1 ([ENG automatically stops]), drive force collapsing.

Incidentally, when the driver further applies brakes, in the event that the solenoid valve SV is closed, the further application of brakes is implemented through the check valve CV only, it is anticipated that the further application cannot be implemented comfortably. However, in this embodiment, when a further application is detected, since the supply of breaking current to the solenoid valve SV is stopped as shown in FIG. 9(b) (refer to step S15 in FIG. 8), the solenoid valve SV is opened so as to facilitate the attempted further application. Note that since the supply of breaking current is resumed when the further application is completed, the solenoid valve SV is closed, and the brake hydraulic pressure that has resulted after the completion of the further application is retained at the wheel cylinders WC. FIG. 9(a) shows an increase in brake hydraulic pressure (braking force) that has resulted by virtue of the further application.

Next, the driver releases the depression of the brake pedal BP in preparation for restart. In a case where the driver depresses the brake pedal BP so hard that the set pressure of the relief valve RV (the relief pressure) is reached or exceeded, by releasing the depression of the brake pedal BP, the relief valve is activated so as to reduce the brake hydraulic pressure (braking force) down to the relief pressure within a short period of time. With this relief valve RV, the vehicle can be started quickly on a rising slope even in a case where the driver depresses the brake pedal BP that hard.

When the brake hydraulic pressure is reduced down to or lower than the relief pressure, the brake hydraulic pressure retained at the wheel cylinders WC by virtue of the action of the solenoid valve SV and the check valve CV of the braking force retaining unit RU is reduced gradually, and in association therewith, the braking force is reduced gradually. The suppression of reversing of the vehicle is attained by this braking force which is still retained while being reduced gradually.

Since the brake switch BSW becomes OFF by releasing the depression of the brake pedal BP while both brake hydraulic pressure and braking force are reduced gradually, the prime mover stopping unit generates an instruction to automatically start the engine. Then, after a time lag due to delay associated with signal communication and mechanical movement, the engine 1 is automatically started, and a supply of pressurized fluid to the starter clutch is started, whereby drive force is built up.

Incidentally, when the engine 1 is stopped, working fluid within a hydraulic chamber of the starter clutch of the CVT 3 is removed therefrom. Due to this, when the engine 1 is started and the supply of pressurized fluid to the starter clutch is initiated, firstly, a drive force rises abruptly (an abrupt rise of drive force in the [supply of pressurized fluid]). Then, since the working fluid within the hydraulic chamber is withdrawn therefrom to thereby generate an idle stroke (a play) on a pushing piston while the engine 1 is at halt, an oil pressure instruction value to the starter clutch does not coincide with an actual oil pressure value, and the drive force transmitting capacity of the starter clutch is only increased gradually until the hydraulic chamber is filled with working fluid. As a result, drive force increases gradually. Then, when the hydraulic chamber is filled with working fluid, drive force increases according to an oil pressure value given.

In a process in which the drive force reaches the strong creeping state, the control unit CU stops the supply of breaking current to the solenoid valve SV so as to open the solenoid valve SV, whereby braking force collapses and hence the vehicle is started from rest.

A timing to open the solenoid valve SV is a time determined by a creep rising timer (a lapse of a predetermined period of time) since the supply of pressurized fluid to the starter clutch of the CVT 3. When this time is reached, a signal to release brake hydraulic pressure (a creep raising signal) is generated, and the solenoid valve SV is opened as shown in FIG. 7B on condition that the brake switch BSW is OFF. Thus, the reason why the creep rising is determined by the timer is because since, as has been described above, working fluid within the hydraulic chamber of the starter clutch is withdrawn therefrom while the engine 1 is at halt, the oil pressure instruction value to the starter clutch does not coincide with the actual oil pressure (the drive force transmitting capacity).

Note that in the line showing braking force in FIG. 9(a), an imaginary line that extends obliquely downwards to the right from a portion thereof indicated as relief pressure indicates a case where brake hydraulic force is not retained. In this case, since braking force decreases without any delay from the reduction in depressing force applied to the brake pedal BP, a start from rest on a rising slop cannot be carried out easily. In addition, this imaginary line also indicates a situation in which the brake pedal BP returns.

### Other Embodiments

The invention is not limited to the embodiment that has been described heretofore but may be embodied in various forms. For example, (refer appropriately to FIGS. 1 to 9) the invention may be applied to a brake unit or system of a vehicle in which an anti-lock braking system, a system which controls traction on drive wheels by virtue of braking force and a system which controls the behavior of the vehicle by virtue of braking force are installed.

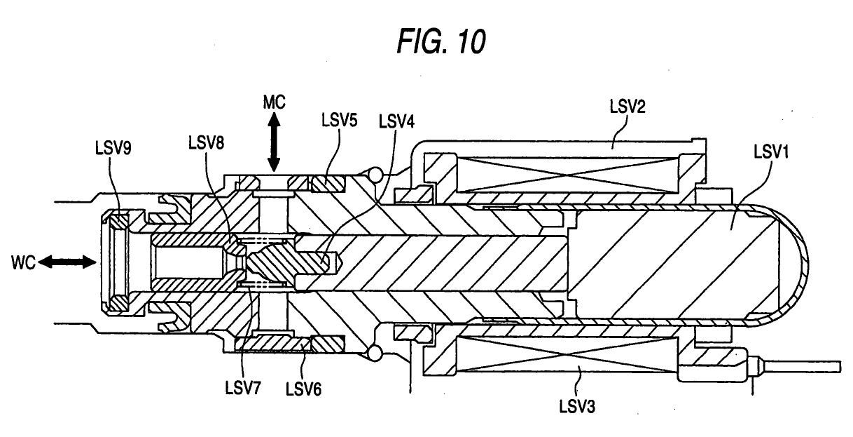

In addition, as the solenoid valve SV, a proportional solenoid valve LSV as shown in FIG. 10 may be used which can control the flow rate of brake fluid. FIG. 10 is a drawing which shows the configuration of the proportional solenoid valve LSV, and as shown in FIG. 10, the proportional solenoid valve LSV is configured so as to include an armature LSV1, a yoke LSV2, a coil LSV3, a seal rod LSV4, an O ring LSV5, a filter LSV6, a return spring LSV7, a seat LSV8, a filter LSV9 and the like. In this proportional solenoid valve LSV, an electromagnetic force generated by the coil LSV3 shifts the seal rod LSV4 in a direction in which the valve is closed (a direction in which the flow of brake fluid is cut off), whereas the spring force of the return spring LSV7 and a differential brake hydraulic pressure between upstream and downstream brake hydraulic pressures shift the seal rod LSV4 in a direction in which the valve is opened.

Namely, this proportional solenoid valve LSV is such as to generate a cut-off force according to the current value of breaking current supplied in such a manner that a large cut-off force is generated when the current value is large, whereas when the current value is small, a small cut-off force is generated and to retain a brake hydraulic pressure corresponding to a cut-off force so generated. Even when the proportional solenoid valve LSV that is configured as has been described above is used, when attempting to further apply brakes, the implementation of a further application is facilitated due to the opening/closing instruction unit CU2 reducing the current value of breaking current or making it zero.

In addition, while the solenoid valve SV is closed (brake hydraulic pressure is retained) when the condition shown in FIG. 4 is met, the condition for closing the solenoid valve SV is not limited the condition shown in FIG. 4. For example, the solenoid valve SV may be conditioned to be closed on condition that the driver releases the depression of the brake pedal BP and brake hydraulic pressure is reduced by a predetermined value or lager. Incidentally, in the event that such a condition is adopted, while the solenoid valve SV is opened after the release of the depression of the brake pedal shown in FIG. 9, in the event that a further application of brakes is implemented in between closure and opening of the valve, the control unit CU (the opening/closing instruction unit CU2) reduces the current value of breaking current supplied to the solenoid valve SV or makes the current value zero so as to facilitate the further application of brakes. Of course, the condition for opening the solenoid valve SV is not limited to the condition shown in FIG. 5. For example, the solenoid valve SV may be designed to be opened when the driver depresses the accelerator pedal.

In addition, while as the cut-off valve, the solenoid valve SV adapted to be activated when an electric current is supplied thereto is described as an example, a valve may be used which is activated when hydraulic or pneumatic pressure is supplied thereto. In addition, a valve such as a diaphragm valve or a needle valve may be used in which the opening of the valve can be varied. In addition, the solenoid valve SV may be of a normally closed type.

In addition, while the further application is detected by the brake hydraulic pressure sensors PS1, PS2, the further application of brakes may be detected by a means such as the pedal effort sensor provided on the brake pedal BP and the pedal stroke sensor also provided on the brake pedal BP. Note that either of the brake hydraulic pressure sensors PS1, PS2 can be detect a further application of brakes. Incidentally, in the case of the embodiment that has been described above, since there is no case where the solenoid valve SV is opened when a large differential pressure exists between the master cylinder MC and the wheel cylinders WC due to the brake hydraulic pressure generated in the master cylinder MC being low, a shock attributed to a large differential pressure is prevented from being applied to the foot of the driver when the solenoid valve SV is opened.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A braking force retaining unit, comprising:
a cut-off valve disposed between a master cylinder and wheel cylinders in a brake hydraulic circuit, the cut-off valve being adopted to retain predetermined brake hydraulic pressure until a predetermined releasing condition is established even after the depression of a brake pedal is released when a vehicle is stopped;
a one-way valve provided in parallel with the cut-off valve and adapted to permit a one-way passage of a brake fluid from a master cylinder side to a wheel cylinder side;
a further application detecting sensor for detecting a further application of brakes;
a further application determination unit for determining on an existence of the further application of brakes based an input from the further application detecting sensor; and
a valve control unit for opening the cut-off valve when the further application determination unit determines that the further application of brakes is occurred.

2. The braking force retaining unit as set forth in claim 1, wherein
the cut-off valve generates a cut-off force according to a current value supplied thereto in such a manner that the cut-off valve generates a large cut-off force when the current value supplied is large, whereas when the current value supplied is small, the cut-off valve generates a small cut-off force, so as to cut off a flow of brake fluid in the brake hydraulic circuit, and
the valve control unit reduces the current value, which is to be supplied to the cut-off value, or to make the current value zero, when the further application determination unit determines that the further application of brakes is occurred.

3. The braking force retaining unit as set forth in claim 1, wherein the further application detecting sensor is configured so as to detect a further application of brakes based on an input value that is supplied from at least one of:
a pressure sensor provided in the brake hydraulic circuit,
a brake pedal effort sensor provided in the brake pedal, and
a pedal stroke sensor provided in the brake pedal.

4. The braking force retaining unit as set forth in claim 1, wherein
the braking force retaining unit changes over a creeping drive force according to depressing conditions of the brake pedal between a large state and a small state which are both preset when a prime mover is idling and the vehicle is moving at a predetermined vehicle speed or smaller, and
the braking force retaining unit is installed on a vehicle which is provided further with a drive force control unit which puts the creeping drive force in the preset small state when the brake pedal is depressed and puts the creeping drive force in the preset large state when the depression of the brake pedal is released.
